(19) United States
(12) Patent Application Publication
(10) Pub. No.: US 2026/0012963 A1
(43) Pub. Date: Jan. 8, 2026

(54) CLUSTERING OF ACCESS POINTS AND WIRELESS CHANNEL ASSIGNMENT

(71) Applicant: Charter Communications Operating, LLC, St. Louis, MO (US)

(72) Inventors: Dileep Kumar Soma, Denver, CO (US); Tohme Tohme, Parker, CO (US)

(21) Appl. No.: 18/765,626

(22) Filed: Jul. 8, 2024

(51) Int. Cl. H04W 72/29; H04W 16/10; H04W 24/02; H04W 72/541

(52) U.S. Cl. CPC H04W 72/29; H04W 16/10; H04W 24/02; H04W 72/541

(57) ABSTRACT

A system as discussed herein includes a communication management resource operative to manage wireless communications in a network environment. The communication management hardware receives feedback indicating signal quality, and operating channel of wireless access points receiving wireless communications from each other in the network environment. The communication management resource groups the wireless access points into one or more clusters based on the received feedback indicating the signal quality. Based on the grouping, the communication management resource further assigns different wireless channels for use by respective wireless access points in each cluster of the multiple clusters.

### BACKGROUND

With many wireless devices making their way into everyday lives, even 5 GHz band is becoming crowded, which results in higher wireless interference. The higher wireless interference amongst multiple communicating communication devices competing for use of wireless bandwidth directly translates to lower wireless transmission speeds for the end customer.

To address this issue, service providers may implement so-called off-channel scanning (OCS) to scan non-operating channels and determine whether the unused channel have lower wireless interference compared to the current operating channel. In theory, this would enable the end customer to use a wireless channel with low interference. For operational reasons, channel changes amongst wireless access points as a response to off-channel scanning may occur once every 24 hrs.

### BRIEF DESCRIPTION

In accordance with examples as discussed herein, a communication management resource can be configured to receive feedback indicating signal quality, and operating channel associated with wireless access points receiving wireless communications in a network environment. Based on feedback, the communication management resource groups the wireless access points into multiple clusters. The communication management resource then assigns one or more wireless channels for use by wireless access points in each of the multiple clusters based on the grouping.

In accordance with further examples as discussed herein, the communication management resource can be configured to use the feedback to determine different levels of wireless interference susceptibility amongst the wireless access points in the network environment. The communication management resource groups the wireless access points into the multiple clusters based on the determined different levels of wireless interference susceptibility amongst the wireless access points.

Still further examples as discussed herein include partitioning the wireless access points into the multiple clusters independent of knowing actual locations of the wireless access points in the network environment.

Yet further, examples of grouping the wireless access points into the multiple clusters includes the communication management resource or other suitable entity: receiving wireless channel availability information indicating a value M indicating a number of the wireless channels available for assigning to the wireless access points; and based on a magnitude of the value M, selecting a first portion of the wireless access points for inclusion in a first cluster of the multiple clusters. In one example, the first portion of the wireless access points includes N wireless access points; N may be less than or equal to M.

In one example, the feedback indicates signal quality, and operating channel associated with the wireless access points receiving the wireless communications from each other over a first wireless channel.

In still further examples, the wireless access points may include a first wireless access point and a second wireless access point. Grouping of the wireless access points into the multiple clusters may include the communication management resource producing a first cluster of the multiple clusters to include the first wireless access point and the second wireless access point in response to detecting that the first wireless access point and the second wireless access point are susceptible to causing wireless interference to each other above a threshold level when using the same wireless channel.

Note further that assignment of the wireless channels for use by the wireless access points in the multiple clusters based on the grouping may include: in response to detecting that the first wireless access point and the second wireless access point belong to the first cluster: i) assigning the first wireless access point use of a first wireless channel, and ii) assigning the second wireless access a second wireless channel, the second wireless channel different than the first wireless channel.

As further as discussed herein, the operations of the communication management resource grouping the wireless access points into the multiple clusters may include producing a second cluster of the multiple clusters to include the second wireless access point and a third wireless access point in response to detecting that the second wireless access point and the third wireless access point are susceptible to causing wireless interference to each other above the threshold level.

Still further, assignment of the wireless channels for use by the wireless access points in the multiple clusters based on the grouping may include the communication management resource or other suitable entity: in response to detecting that the second wireless access point and the third wireless access point belong to the second cluster and that the second wireless access point is assigned the second wireless channel, assigning the third wireless access point use of a third wireless channel, the third wireless channel different than the second wireless channel.

In accordance with another example, grouping of the wireless access points into multiple clusters may include the communication management resource grouping first wireless access points in a first cluster of the multiple clusters and grouping second wireless access points in the second cluster of the multiple clusters. The first cluster may include multiple wireless access points such as including a first wireless access point; the second cluster may include the first wireless access point as well. Still further, assignment of the wireless channels for use by the wireless access points may include the communication management resource preventing assignment of a same wireless channel for use by multiple wireless access points assigned to a given cluster of the multiple clusters. In other words, because it is known that members of the cluster are susceptible to wireless interference when they use the same wireless channel, members of the given cluster as discussed herein are assigned different wireless channels to avoid wireless interference amongst them.

Yet further examples as discussed herein include an instance in which the communication management resource groups first wireless access points into a first cluster of the multiple clusters. Assignment of one or more wireless channels for use by the first wireless access points in the first cluster includes assigning each of first wireless access points in the first cluster use of a different wireless channel.

Techniques as discussed herein are useful over conventional techniques. For example, one or more implementation of a communication management resource and corresponding operations as discussed herein provide better use of a respective wireless network to more efficiently convey data.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes computer readable storage hardware having instructions stored thereon. The instructions, when executed by corresponding computer processor hardware, cause the computer processor hardware (such as one or more co-located or disparately processor devices or hardware) to: receive feedback indicating signal quality, and operating channel associated with wireless access points receiving wireless communications over a shared wireless channel in a network environment; group the wireless access points into multiple clusters based on the received feedback indicating the signal quality; and assign one or more wireless channels for use by respective wireless access points in each of the multiple clusters based on the grouping.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of controlling conveyance of data packets in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment including multiple wireless access points providing wireless connectivity to multiple communication devices and management of allocating wireless channels as discussed herein.

FIG. 2 is an example diagram illustrating broadcast of a respective wireless signal from each of multiple wireless access points and generation of neighbor access point and channel interference information as discussed herein.

FIG. 3 is an example diagram illustrating operation of multiple wireless access points in a network environment as discussed herein.

FIG. 4A is an example diagram illustrating collection of neighbor information as discussed herein.

FIG. 4B is an example diagram illustrating collection of neighbor information as discussed herein.

FIG. 4C is an example diagram illustrating collection of neighbor information as discussed herein.

FIG. 4D is an example diagram illustrating collection of neighbor information as discussed herein.

FIG. 4E is an example diagram illustrating collection of neighbor information as discussed herein.

FIG. 4F is an example diagram illustrating collection of neighbor information as discussed herein.

FIG. 5 is an example diagram illustrating generation of cluster management information including groupings of different wireless access points and corresponding allocation of different wireless channels as discussed herein.

FIG. 6 is an example diagram illustrating logical groupings of different wireless access points and wireless channel allocation as discussed herein.

FIG. 7A is an example diagram illustrating collection of neighbor information as discussed herein.

FIG. 7B is an example diagram illustrating collection of neighbor information as discussed herein.

FIG. 7C is an example diagram illustrating collection of neighbor information as discussed herein.

FIG. 7D is an example diagram illustrating collection of neighbor information as discussed herein.

FIG. 7E is an example diagram illustrating collection of neighbor information as discussed herein.

FIG. 7F is an example diagram illustrating collection of neighbor information as discussed herein.

FIG. 8 is an example diagram illustrating example computer hardware and software operable to execute operations as discussed herein.

FIG. 9 is an example diagram illustrating a method as discussed herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

Off-channel scanning (a.k.a., OCS) is effective at places where there is higher number of wireless devices/routers operating in a relatively small area and where interference may occur. If all wireless access points (a.k.a., routers) operate in the same channel to begin with, then OCS will switch all routers to an off-channel simultaneously. This channel changes occurs in a loop as all the router will be in the same channel at all times.

For a given large service provider, the chance of many routers associated with that given large service provider operating in a similar location is high. For example, 75% of routers may be providing wireless access via wireless channel 157 as default for supporting wireless communications in accordance with wireless communication protocol WiFi-6.

As a further example, assume that there are 50 routers (a.k.a., wireless access points) operating in location Loc1 and a majority of routers reside in channel X while any remaining routers reside in channel Y.

Assume further that the routers operating in wireless channel X report off-channel interference rates to be p % and on-channel to be q % (q>>p).

Similarly, assume that routers operating with wireless channel Y report off-channel interference rates to be q % and on-channel to be p %.

In such an instance, routers using wireless channel X are advised to switch to using wireless channel Y, while routers using wireless channel Y continue to use wireless channel Y. Now, all routers end up using wireless channel Y which results in high interference. When the routers implement off-channel scanning again, wireless channel X appears to be free from interference they'll switch back together to using wireless channel X. This ping-pong effect results in high amounts of wireless interference because all of the wireless access points are using the same channel to support wireless communications with corresponding mobile communication devices.

As discussed herein, to avoid the looping (ping-pong) of channel changes in network environments as previously discussed, as well as to avoid high wireless interference, implementation of variables such as self-interference and location to make channel switches should be considered.

With location awareness for routers reporting OCS (Off-channel Scanning) information, a cloud management resource can be configured to combine received neighbor reports and interference information from the wireless access points with location information indicating locations of routers as a whole to control wireless channel allocation amongst the different wireless access points.

In the above example, after initial reporting of neighboring AP information and channel interference information, if location is added to the equation, only part of routers operating in wireless channel X will switch to wireless channel Y while others remain in wireless channel X to avoid crowding in a single channel. It is not always possible to track exact locations of wireless access points either due to measurement inaccuracies or absence of locationing equipment in the access points and use such information to allocate wireless channels.

In one example, a communication management resource creates clusters for the access points based on received neighbor access point information and available channel list. The access points are clustered based on those susceptible to high wireless interference amongst each other. This typically will be access ones that are near each other.

For example, each respective cluster can be configured to have X number of access points, where X number of distinct available channels is assigned to the respective cluster. Each wireless access point in the respective cluster is assigned a different wireless channel of the X wireless channels. Assignment of the different wireless channels reduces wireless interference amongst wireless access points in the cluster.

Each cluster of access points can be configured to include neighboring access points susceptible to wireless interference such as those wireless access points that experience highest SNR (Signal Noise Ratio) values associated with receiving wireless signals from each other.

In one example, the communication management resource as discussed herein receives the neighbor information such as respective SNR values or other suitable measured interference information using On-Channel and Off-Channel scanning.

The communication management resource such as disposed in a cloud network receives the neighbor information and keeps track of corresponding clusters of wireless access points.

Each access point in a corresponding cluster may be assigned to a distinct wireless channel not used by any other wireless access points in the corresponding cluster.

If an unmanaged access point (such as a wireless access point residing outside of a corresponding service provider network managed by the communication management resource) is determined to be a neighboring access point with the highest SNR values, the channel that the unmanaged AP uses will be blocked and reserved in this cluster for the unmanaged wireless access point. This is because the service provider is unable to change the wireless channel used by that unmanaged wireless access point.

The communication management resource such as disposed in a cloud network can be configured to maintain a list of wireless access points that are already assigned channels within a respective cluster. In such an instance, if a wireless access point has been assigned to a specific channel, its assignment will not be changed if it appears in another cluster again.

Additionally, after creating the respective clusters, all wireless access points in the respective clusters are assigned new wireless channels, and the cloud (communication management resource) sends commands to the different wireless access points to use a specific wireless channel that has been assigned to it.

If desired, a first wireless access point needs cluster can be randomly assigned and available wireless channel. However, as discussed herein, the wireless channels assigned to the wireless access points in a cluster may be contingent upon whether any of the wireless access points in the instant cluster are included as members and multiple clusters. This is discussed in more detail below.

### Without Location Aware OCS:

Assume that the communication management resource has two distinct wireless channels available such as channel A and Channel B for assignment to wireless access points in a cluster.

Assume further that multiple wireless access points (a.k.a., APs) wireless access point AP1 and wireless access point AP2 are close to each other and broadcast on-channel A, which causes high interference on-channel A.

Both of the wireless access points AP1 and AP2 perform an Off-channel scan and detect that wireless channel B has significantly lower interference than wireless channel A.

The cloud management resource (managing allocation of wireless channels) sends configuration notifications for the APs to change channels to a channel with lower interference; in such an instance, both APs will switch to using channel B.

Now both APs are on the same channel again, which will cause high interference on-channel B. The techniques as discussed herein provide a solution to this problem.

### With Location Aware OCS:

Assume that the communication management resource has two distinct channels available such as wireless channel A and wireless channel B.

Wireless access points AP1 and AP2 are close to each other and broadcast on-channel A, which causes high interference on-channel A.

Both wireless access points AP1 and AP2 perform an Off-channel scan (monitoring channel B) and to determine which of the wireless access points are neighboring APs and produce respective SNR values (a.k.a., wireless interference susceptibility information) based on receiving wireless signals from those other neighboring access points. The wireless access points communicate the collected information and send it to the communication management resource in the cloud or disposed at some other suitable location.

The communication management resource in the cloud creates a first cluster including the wireless access point AP1 and the wireless access point AP2 because they are known to cause interference to each other.

The communication management resource assigns channel A to wireless access point AP1 and channel B to wireless access point AP2 in the cluster. This enables each of these wireless access points in the same cluster to communicate without interfering with each other.

After all access points in all clusters get assigned channels, the communication management resource can be configured to send configuration information to the wireless access points to switch to their newly assigned channels (which may be the same as their previously assigned wireless channels or different from a previous wireless channel assignment).

Now wireless access point AP1 will be assigned wireless channel A, and wireless access point AP2 will be assigned wireless Channel B. In such an instance, as mentioned, these two neighboring APs in the same cluster will not cause interference to each other.

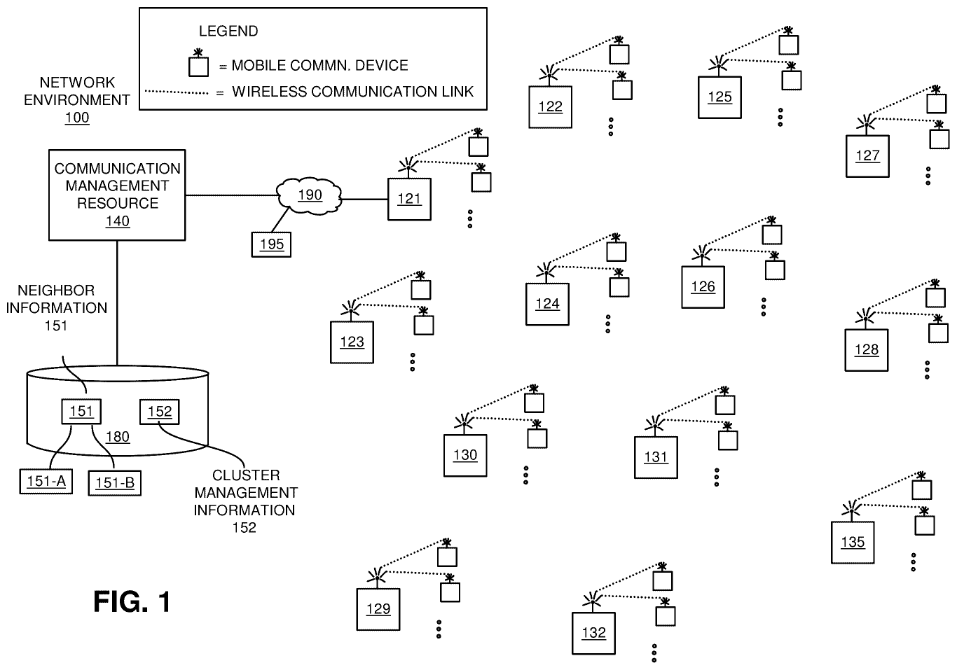

Now, more specifically, with reference to the drawings, FIG. 1 is an example diagram illustrating a network environment including multiple wireless access points as discussed herein.

As shown in FIG. 1, the network environment 100 includes communication management resource 140, repository 180, network 190, and multiple wireless access points providing wireless connectivity to multiple communication devices.

Note that each of the resources as discussed herein can be configured as communication hardware, communication software, or a combination of communication hardware and communication software. More specifically, the communication management resource 140 can be configured as communication management hardware, communication management software, or a combination of communication management hardware and communication management software; each wireless access point can be configured as wireless access hardware, wireless access point software, or a combination of wireless access point hardware wireless access point software, and so on.

Each of the wireless access points as discussed herein provides corresponding mobile communication devices wireless access (such as via a respective wireless communication link) to the respective wireless access point. The respective wireless access point conveys uplink communications received from the communication devices and forwards them to the network 190 for delivery to the one or more target destinations. Note that server resource 195 is an example of a source of communicating data packets to the communication devices or a target destination to which communications are transmitted. A respective wireless access point also supports downlink communications received from the network 190 and forwards them to the appropriate mobile communication device.

As further shown, the multiple wireless access points include: wireless access point 121 providing corresponding mobile communication devices access to the network 190 through the wireless access point 121, wireless access point 122 providing corresponding mobile communication devices access to the network 190 through the wireless access point 122, wireless access point 123 providing corresponding mobile communication devices access to the network 190 through the wireless access point 123, wireless access point 124 providing corresponding mobile communication devices access to the network 190 through the wireless access point 124, wireless access point 125 providing corresponding mobile communication devices access to the network 190 through the wireless access point 125, wireless access point 126 providing corresponding mobile communication devices access to the network 190 through the wireless access point 126, wireless access point 127 providing corresponding mobile communication devices access to the network 190 through the wireless access point 127, wireless access point 128 providing corresponding mobile communication devices access to the network 190 through the wireless access point 128, wireless access point 129 providing corresponding mobile communication devices access to the network 190 through the wireless access point 129, wireless access point 130 providing corresponding mobile communication devices access to the network 190 through the wireless access point 130, wireless access point 131 providing corresponding mobile communication devices access to the network 190 through the wireless access point 131, wireless access point 132 providing corresponding mobile communication devices access to the network 190 through the wireless access point 132, wireless access point 135 providing corresponding mobile communication devices access to the network 190 through the wireless access point 135, and so on.

As further shown, the communication management resource 140 has access to corresponding neighbor information 151 stored in the repository 180. The neighbor information 151 can be configured to include neighbor information 151-A as well as channel interference information 151-B. Additional details of the neighbor information as further discussed below.

In general, in one example, the neighbor information 151-A includes information such as neighbor ID (identifier), operating channel used by the corresponding neighbor wireless access point as indicated by the neighbor ID, operating bandwidth and SNR of the corresponding neighbor.

The channel interference information 151-B can be configured to include wireless interference information on a per channel basis as measured by the corresponding wireless access points.

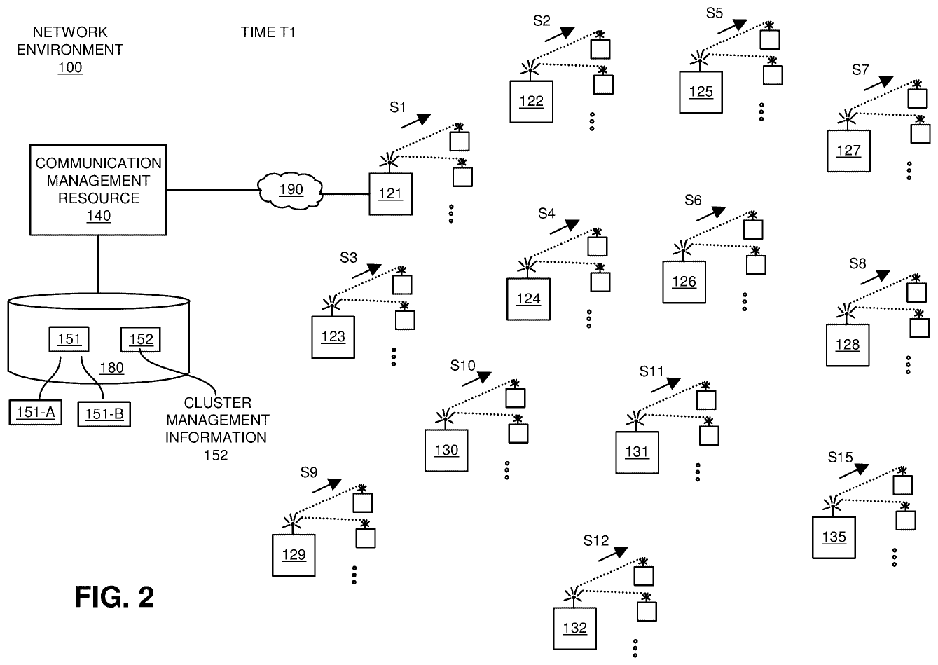

FIG. 2 is an example diagram illustrating broadcast of a respective wireless signal from each of multiple wireless access points and generation of neighbor access point and channel interference information as discussed herein.

In this example, each respective wireless access point of the wireless access points in the network environment 100 monitors for presence of wireless signals such as wireless beacons or other wireless signals transmitted from neighboring wireless access points.

In one example, a parameter such as RSSI can be used to determine signal quality associated with the monitoring wireless access point receiving wireless signals from other wireless access points. The monitoring of received wireless signals (such as based on RSSI) provides information (used to determine the signal quality) about how close a first access point device transmitting a respective wireless signal is to the respective monitoring wireless access point. In one example as further discussed herein, the monitoring wireless access point receiving wireless signals measures the transmitted wireless signals from other wireless access points.

Each respective wireless access point of the wireless access points also may be assigned a respective wireless channel in which to support communications with corresponding communication devices as previously discussed. It is desirable that the wireless access points in the same region near each other are assigned different wireless channels so they do not interfere with each other. The assignment of wireless channels can be changed on as-needed basis to reduce interference amongst the wireless access points disposed in the network environment 100.

Note that a respective wireless access point may monitor for presence of the wireless signals in the same channel that the respective wireless access point is using to support wireless communications with corresponding communication devices. This is called on-channel scanning.

Additionally, the respective wireless access point can be configured to monitor for presence of wireless signals from other neighboring wireless access points over different possible wireless channels assigned to the other wireless access points in the network environment 100. This is called off-channel scanning.

Accordingly, each respective wireless access point in the network environment 100 can be configured to implement on-channel scanning and/or off-channel scanning.

More specifically, assume that the the wireless access point 121 in FIG. 2 has been assigned a first wireless channel B to support communications with corresponding mobile communication devices via respective communication links. The wireless access point 121 transmits (such as broadcasts) the wireless signal S1 (such as a beacon signal) indicating the availability of the wireless access point 121 in the network environment 100. The signal S1 transmitted from the wireless access point 121 may include any suitable information such as a unique identity assigned to the wireless access point 121, the power level at which the wireless access point 121 transmitted corresponding signal S1, etc.

The wireless access points other than wireless access point 121 monitor the first wireless channel for the presence of the wireless signal S1 transmitted by the wireless access point 121. Some of the wireless access points may be sufficiently close to the wireless access point 121 that they receive the signal S1 at a high signal-to-noise ratio level or high wireless power level; other wireless access points may be sufficiently far away from the wireless access point 121 that the magnitude of the signal-to-noise ratio level or wireless power level of the received signal S1 is very low or not received at all.

Based on monitoring of the wireless signal S1 over wireless channel B, each recipient wireless access point of the wireless signal S1 determines a corresponding degree of wireless signal quality associated with receiving communications from the wireless access point 121 based on any suitable parameter such as a signal-to-noise ratio of receiving the respective signal S1, a power level of receiving the respective wireless signal S1, etc.

Each of the neighboring wireless access points records this information for every other wireless access point from which it receives a respective wireless signal.

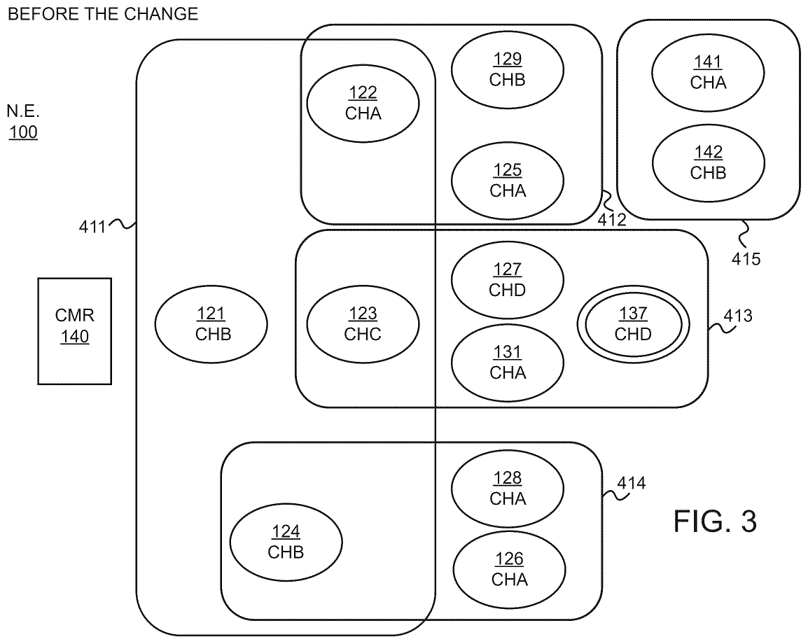

An example of the monitor information produced by each of the wireless access points monitoring the wireless signals generated by the wireless access points is shown and discussed in FIG. 3.

FIG. 3 is an example diagram illustrating a current configuration of a respective network environment as discussed herein.

This example illustrates how each of the wireless access points can be initially assigned a respective channel to communicate with one or more mobile communication devices in a manner as previously discussed.

For example, the wireless access point 121 is assigned use of wireless channel B to support respective wireless communications with one or more mobile communication devices in a vicinity of wireless access point 121; wireless access point 122 is assigned use of wireless channel A to support respective wireless communications with one or more mobile communication devices in a vicinity of wireless access point 122; the wireless access point 123 is assigned use of wireless channel C to support respective wireless communications with one or more mobile communication devices in a vicinity of wireless access point 123; wireless access point 124 is assigned use of wireless channel B to support respective wireless communications with one or more mobile communication devices in a vicinity of wireless access point 124; the wireless access point 125 is assigned use of wireless channel A to support respective wireless communications with one or more mobile communication devices in a vicinity of wireless access point 125; wireless access point 126 is assigned use of wireless channel A to support respective wireless communications with one or more mobile communication devices in a vicinity of wireless access point 126; the wireless access point 127 is assigned use of wireless channel D to support respective wireless communications with one or more mobile communication devices in a vicinity of wireless access point 127; wireless access point 128 is assigned use of wireless channel A to support respective wireless communications with one or more mobile communication devices in a vicinity of wireless access point 128; the wireless access point 129 is assigned use of wireless channel A to support respective wireless communications with one or more mobile communication devices in a vicinity of wireless access point 129; wireless access point 130 is assigned use of wireless channel B to support respective wireless communications with one or more mobile communication devices in a vicinity of wireless access point 130; the wireless access point 131 is assigned use of wireless channel A to support respective wireless communications with one or more mobile communication devices in a vicinity of wireless access point 131; wireless access point 132 is assigned use of wireless channel C to support respective wireless communications with one or more mobile communication devices in a vicinity of wireless access point 132; and so on.

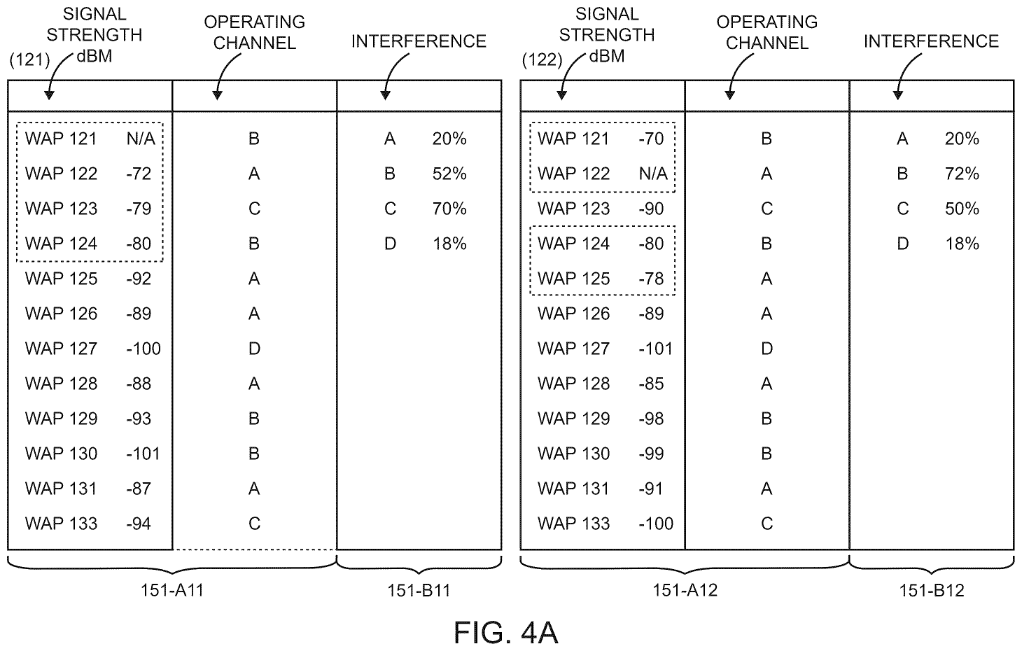

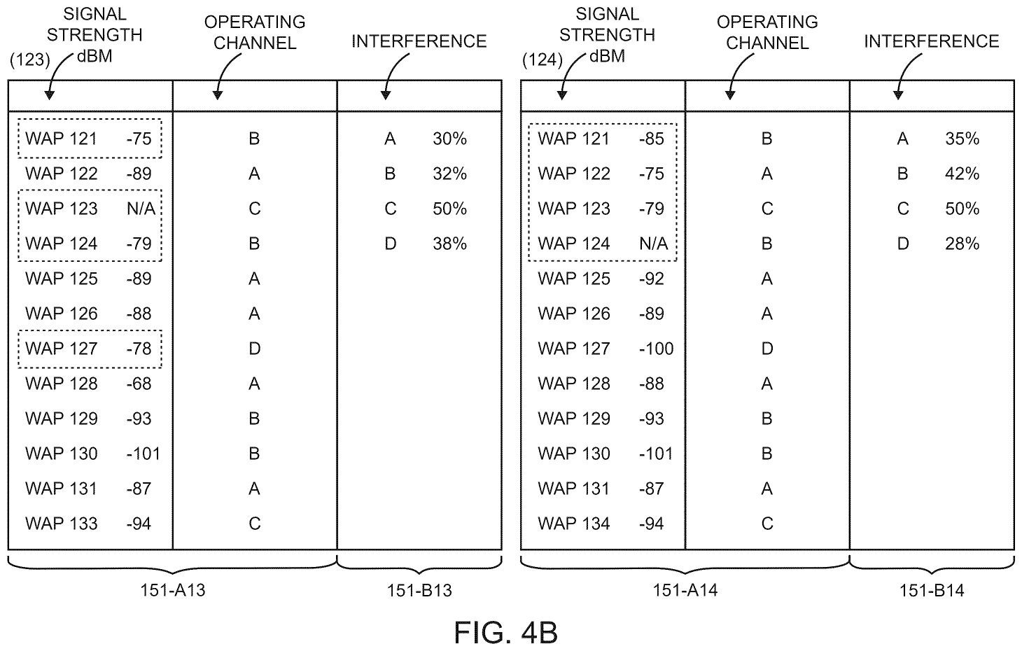

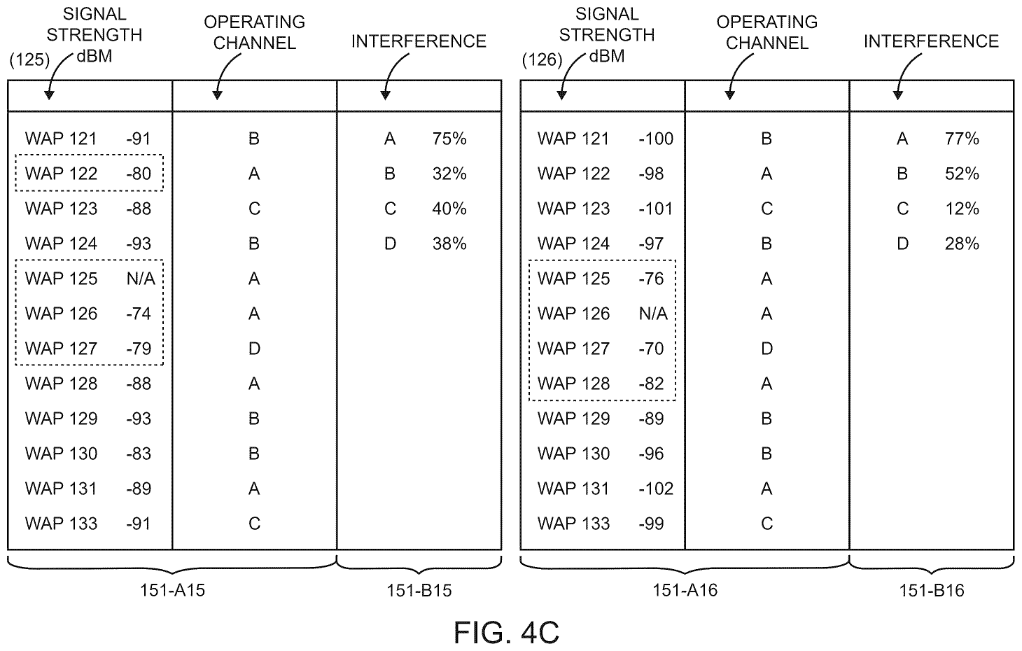

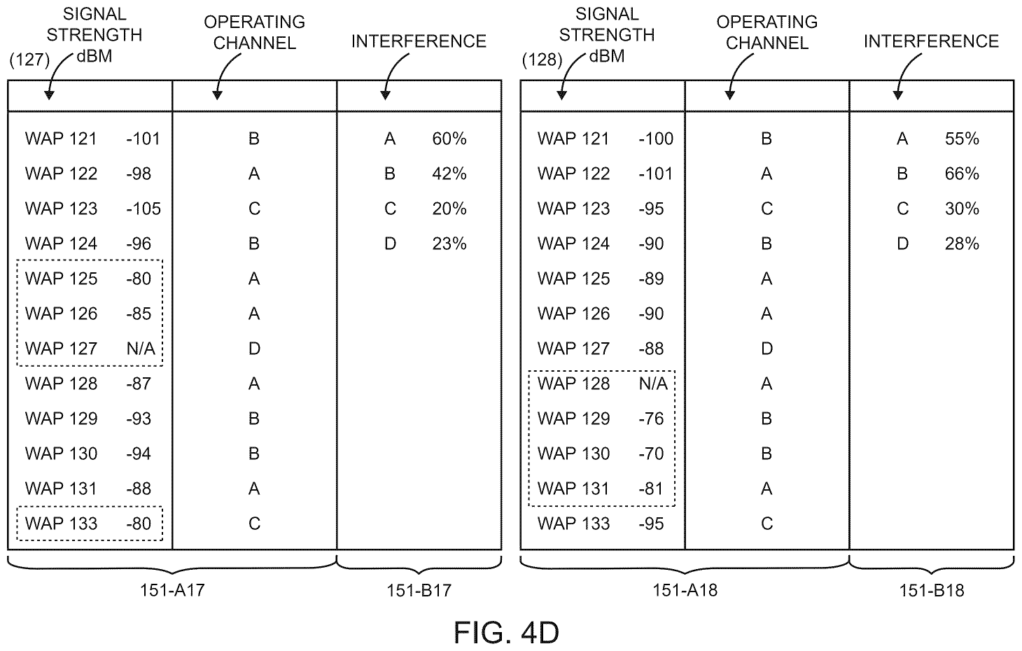

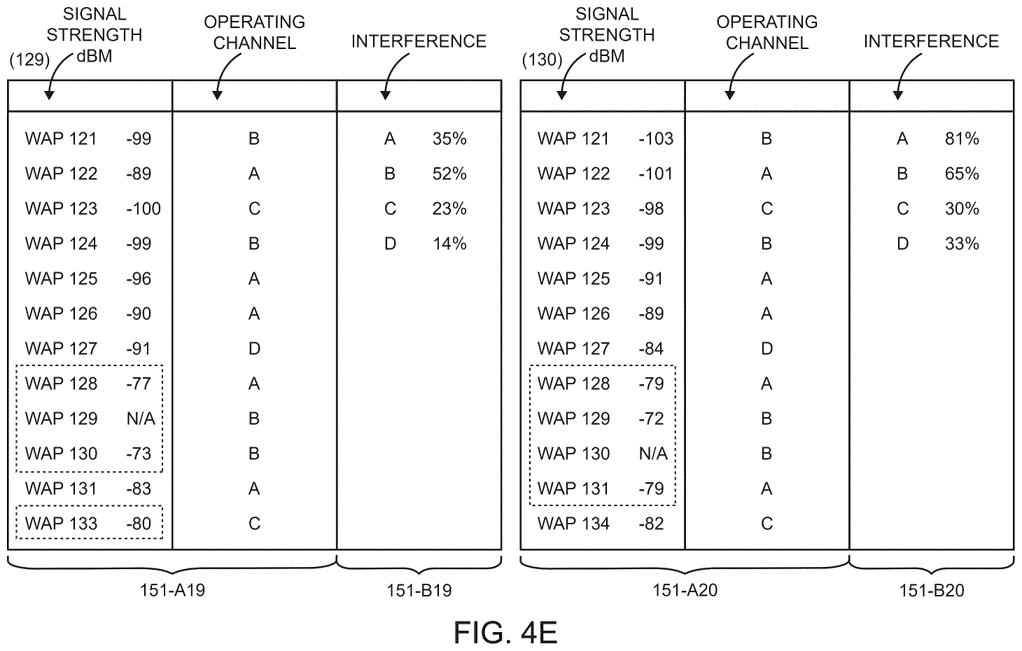

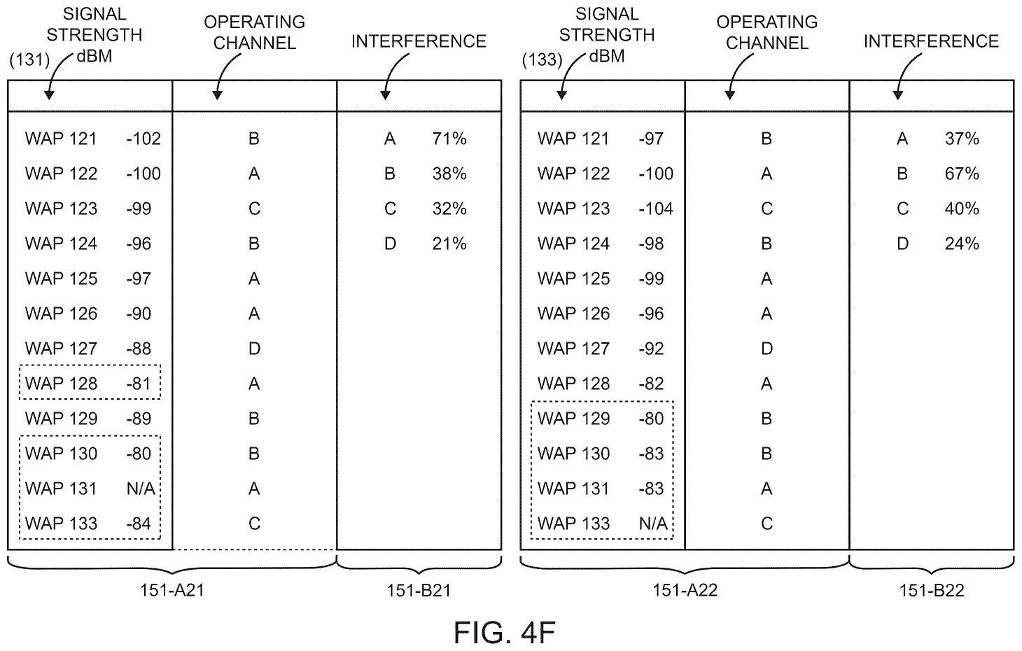

FIGS. 4A, 4B, 4C, 4D, 4E, and 4F are example diagrams illustrating neighbor access point information and channel interference information generated by each of multiple different wireless access points as discussed herein.

As previously discussed, each of the wireless access points produces the respective neighbor interference information 151-Ax and 151-Bx (where X equals 11 for wireless access point 121, where X equals 12 for wireless access point 122, where X equals 13 for wireless access point 123, etc.) based on monitoring the network environment 100 for wireless signals generated by each of the other wireless access points. Each of the wireless access points can be configured to transmit their respective signal such as one of signal S1, S2, S3, S4, S5, S6, S7, S8, S9, S10, S11, etc., at a corresponding frequency (channel) assigned to that wireless access point as previously discussed.

For example, wireless access point 121 may be assigned use of wireless channel B to communicate with respective communication devices and broadcast signal S1; wireless access point 122 may be assigned use of wireless channel A to communicate with respective communication devices and broadcast signal S2; wireless access point 123 may be assigned use of wireless channel C to communicate with respective communication devices and broadcast signal S3; wireless access point 124 may be assigned use of wireless channel B to communicate with respective communication devices and broadcast signal S4; wireless access point 125 may be assigned use of wireless channel A to communicate with respective communication devices in broadcast signal S5; wireless access point 126 may be assigned use of wireless channel A to communicate with respective communication devices and broadcast signal S6; wireless access point 127 may be assigned use of wireless channel D to communicate with respective communication devices and broadcast signal S7; wireless access point 128 may be assigned use of wireless channel A to communicate with respective communication devices in broadcast signal S8; wireless access point 129 may be assigned use of wireless channel B to communicate with respective communication devices in broadcast signal S9; wireless access point 130 may be assigned use of wireless channel B to communicate with respective communication devices and broadcast signal S10; wireless access point 131 may be assigned use of wireless channel A to communicate with respective communication devices and broadcast signal S11; wireless access point 132 may be assigned use of wireless channel C to communicate with respective communication devices in broadcast signal S12; and so on.

When monitoring the network environment for other wireless access points, the wireless access point 121 monitors one or more of channels A, B, C, D, for presence of communications (such as beacons or wireless signals S2, S3, S4, S5, S6, S7, S8, S9, S10, S11, etc.) from other wireless access points. This means that the wireless access point 121 can be configured to perform on-channel scanning (monitoring channel B) as well as off-channel scanning (monitoring channels A, C, D).

When monitoring the network environment for other wireless access points, the wireless access point 122 monitors one or more of channels A, B, C, D, for presence of communications (such as beacons or wireless signals S1, S3, S4, S5, S6, S7, S8, S9, S10, S11, etc.) from other wireless access points. This means that the wireless access point 122 can be configured to perform on-channel scanning (monitoring channel A) as well as off-channel scanning (monitoring channels B, C, D).

When monitoring the network environment for other wireless access points, the wireless access point 123 monitors one or more of channels A, B, C, D, for presence of communications (such as beacons or wireless signals S1, S2, S4, S5, S6, S7, S8, S9, S10, S11, etc.) from other wireless access points. This means that the wireless access point 123 can be configured to perform on-channel scanning (monitoring channel C) as well as off-channel scanning (monitoring channels A, B, D).

When monitoring the network environment for other wireless access points, the wireless access point 124 monitors one or more of channels A, B, C, D, for presence of communications (such as beacons or wireless signals S1, S2, S3, S5, S6, S7, S8, S9, S10, S11, etc.) from other wireless access points. This means that the wireless access point 124 can be configured to perform on-channel scanning (monitoring channel B) as well as off-channel scanning (monitoring channels A, C, D).

When monitoring the network environment for other wireless access points, the wireless access point 125 monitors one or more of channels A, B, C, D, for presence of communications (such as beacons or wireless signals S1, S2, S3, S4, S6, S7, S8, S9, S10, S11, etc.) from other wireless access points. This means that the wireless access point 125 can be configured to perform on-channel scanning (monitoring channel A) as well as off-channel scanning (monitoring channels B, C, D).

When monitoring the network environment for other wireless access points, the wireless access point 126 monitors one or more of channels A, B, C, D, for presence of communications (such as beacons or wireless signals S1, S3, S4, S5, S6, S7, S8, S9, S10, S11, etc.) from other wireless access points. This means that the wireless access point 126 can be configured to perform on-channel scanning (monitoring channel A) as well as off-channel scanning (monitoring channels B, C, D).

When monitoring the network environment for other wireless access points, the wireless access point 127 monitors one or more of channels A, B, C, D, for presence of communications (such as beacons or wireless signals S1, S2, S4, S5, S6, S7, S8, S9, S10, S11, etc.) from other wireless access points. This means that the wireless access point 127 can be configured to perform on-channel scanning (monitoring channel D) as well as off-channel scanning (monitoring channels A, B, C).

When monitoring the network environment for other wireless access points, the wireless access point 128 monitors one or more of channels A, B, C, D, for presence of communications (such as beacons or wireless signals S1, S2, S3, S5, S6, S7, S8, S9, S10, S11, etc.) from other wireless access points. This means that the wireless access point 128 can be configured to perform on-channel scanning (monitoring channel A) as well as off-channel scanning (monitoring channels B, C, D).

When monitoring the network environment for other wireless access points, the wireless access point 129 monitors one or more of channels A, B, C, D, for presence of communications (such as beacons or wireless signals S1, S2, S3, S4, S6, S7, S8, S9, S10, S11, etc.) from other wireless access points. This means that the wireless access point 129 can be configured to perform on-channel scanning (monitoring channel B) as well as off-channel scanning (monitoring channels A, C, D).

When monitoring the network environment for other wireless access points, the wireless access point 130 monitors one or more of channels A, B, C, D, for presence of communications (such as beacons or wireless signals S1, S3, S4, S5, S6, S7, S8, S9, S10, S11, etc.) from other wireless access points. This means that the wireless access point 130 can be configured to perform on-channel scanning (monitoring channel B) as well as off-channel scanning (monitoring channels A, C, D).

When monitoring the network environment for other wireless access points, the wireless access point 131 monitors one or more of channels A, B, C, D, for presence of communications (such as beacons or wireless signals S1, S2, S4, S5, S6, S7, S8, S9, S10, S11, etc.) from other wireless access points. This means that the wireless access point 131 can be configured to perform on-channel scanning (monitoring channel A) as well as off-channel scanning (monitoring channels B, C, D).

When monitoring the network environment for other wireless access points, the wireless access point 133 monitors one or more of channels A, B, C, D, for presence of communications (such as beacons or wireless signals S1, S2, S3, S5, S6, S7, S8, S9, S10, S11, etc.) from other wireless access points. This means that the wireless access point 132 can be configured to perform on-channel scanning (monitoring channel C) as well as off-channel scanning (monitoring channels A, B, D).

In this example, the wireless access point 121 produces the respective neighbor information 151-A11 based on monitoring the network environment 100 for wireless signals generated by each of the wireless access points.

For example, as previously discussed, the wireless access point 121 broadcasts the wireless signal S1 in the network environment 100. Each of the wireless access points monitors one or more different wireless channels for presence of the wireless signal S1.

The wireless access point 121 monitors for presence of the signals S2, S3, S4, S5, S6, S7, S8, S9, S10, S11, etc. As shown in FIG. 4A, the neighbor information 151-A11 generated by the wireless access point 121 indicates a degree to which the wireless access point 121 is able to receive wireless communications transmitted from each of the other wireless access points (wireless access point other than the wireless access point 121).

Assume in this example that the respective magnitude of the value in the signal strength column (dBm) of neighbor information 151-A11 is derived from monitoring each of the different signals S2, S3, S4, S5, S6, S7, S8, S9, S10, S11, . . . , S15, etc. In this example, the signal strength value (such as in dBm) indicates a respective signal strength of the wireless access point 121 receiving corresponding wireless signals from the different wireless access points in the network environment 100. The greater the magnitude of the signal strength value in dBm, the greater the magnitude that a respective wireless signal is received from the one or more transmitting wireless access points. For example, the signal strength values range from −72 dBm to negative −101 dBm. The signal strength value −72 dBm indicates receipt of a respective wireless signal at a higher power level than a corresponding wireless signal received at the power level −101 dBm.

For a first set of samples monitored by each of the wireless access points at or around time T1, the first wireless access point 121 produces the corresponding neighbor interference information 151-A11 to indicate that:
the wireless access point 121 receives the wireless signal S2 transmitted by the wireless access point 122 over wireless channel A at a level of −72 dBm;
the wireless access point 121 receives the wireless signal S3 transmitted by the wireless access point 123 over wireless channel C at a level of −79 dBm;
the wireless access point 121 receives the wireless signal S4 transmitted by the wireless access point 124 over wireless channel B at a level of −80 dBm;
the wireless access point 121 receives the wireless signal S5 transmitted by the wireless access point 125 over wireless channel A at a level of −92 dBm;
the wireless access point 121 receives the wireless signal S6 transmitted by the wireless access point 126 over wireless channel A at a level of −89 dBm;
the wireless access point 121 receives the wireless signal S7 transmitted by the wireless access point 127 over wireless channel D at a level of −100 dBm;
the wireless access point 121 receives the wireless signal S8 transmitted by the wireless access point 128 over wireless channel A at a level of −88 dBm;
the wireless access point 121 receives the wireless signal S9 transmitted by the wireless access point 129 over wireless channel B at a level of −93 dBm;
the wireless access point 121 receives the wireless signal S10 transmitted by the wireless access point 130 over wireless channel B at a level of −101 dBm;
the wireless access point 121 receives the wireless signal S11 transmitted by the wireless access point 131 over wireless channel A at a level of −87 dBm;
the wireless access point 121 receives the wireless signal S13 transmitted by the wireless access point 133 over wireless channel C at a level of −94 dBm; and so on.

Additionally, the wireless access point 121 monitors the degree (such as a percentage of time) to which each of the available wireless channels A, B, C, and D are used by other wireless access points. For example, the wireless access point 121 detects that the wireless channel A is used 20 percent of the time and is not used 80 percent of the time. The wireless access point 121 detects that the wireless channel B is used 52 percent of the time and is not used 48 percent of the time. The wireless access point 121 detects that the wireless channel C is used 70 percent of the time and is not used 30 percent of the time. The wireless access point 121 detects that the wireless channel D is used 18 percent of the time and is not used 82 percent of the time. The wireless access point 121 or other suitable entity stores such information indicating usage (such as interference information) of the different wireless channels over time as interference information 151-B11 as shown in FIG. 4A.

In this example, the wireless access point 122 produces the respective neighbor information 151-A12 based on monitoring the network environment 100 for wireless signals generated by each of the wireless access points.

For example, as previously discussed, the wireless access point 122 broadcasts the wireless signal S2 in the network environment 100. Each of the wireless access points monitors one or more different wireless channels for presence of the wireless signal S2.

The wireless access point 122 monitors for presence of the signals S1, S3, S4, S5, S6, S7, S8, S9, S10, S11, etc. As shown in FIG. 4A, the neighbor information 151-A12 generated by the wireless access point 122 or other suitable entity indicates a degree to which the wireless access point 122 is able to receive wireless communications transmitted from each of the other wireless access points (wireless access point other than the wireless access point 122).

Assume in this example that the respective magnitude of the value in the signal strength column of neighbor information 151-A12 is derived from monitoring each of the different signals S1, S3, S4, S5, S6, S7, S8, S9, S10, S11, . . . , S15, etc. In this example, the signal strength value (such as in dBm) indicates a respective signal strength of the wireless access point 122 receiving corresponding wireless signals from the different wireless access points in the network environment 100. As previously discussed, the greater the magnitude of the signal strength value in dBm, the greater the magnitude that a respective wireless signal is received from the one or more transmitting wireless access points. For example, the signal strength values range from −70 dBm to negative −101 dBm. The signal strength value −70 dBm indicates receipt of a respective wireless signal at a higher power level than a corresponding wireless signal received at the power level −101 dBm.

For a first set of samples monitored by each of the wireless access points at or around time T1, the first wireless access point 122 produces the neighbor interference information 151-A12 to indicate that:
the wireless access point 122 receives the wireless signal S1 transmitted by the wireless access point 121 over wireless channel B at a level of −72 dBm;
the wireless access point 122 receives the wireless signal S3 transmitted by the wireless access point 123 over wireless channel C at a level of −90 dBm;
the wireless access point 122 receives the wireless signal S4 transmitted by the wireless access point 124 over wireless channel B at a level of −80 dBm;
the wireless access point 122 receives the wireless signal S5 transmitted by the wireless access point 125 over wireless channel A at a level of −78 dBm;
the wireless access point 122 receives the wireless signal S6 transmitted by the wireless access point 126 over wireless channel A at a level of −89 dBm;
the wireless access point 122 receives the wireless signal S7 transmitted by the wireless access point 127 over wireless channel D at a level of −101 dBm;
the wireless access point 122 receives the wireless signal S8 transmitted by the wireless access point 128 over wireless channel A at a level of −85 dBm;
the wireless access point 122 receives the wireless signal S9 transmitted by the wireless access point 129 over wireless channel B at a level of −98 dBm;
the wireless access point 122 receives the wireless signal S10 transmitted by the wireless access point 130 over wireless channel B at a level of −99 dBm;
the wireless access point 122 receives the wireless signal S11 transmitted by the wireless access point 131 over wireless channel A at a level of −91 dBm;
the wireless access point 122 receives the wireless signal S32 transmitted by the wireless access point 133 over wireless channel C at a level of −100 dBm; and so on.

Additionally, the wireless access point 122 monitors the degree (such as a percentage of time) to which each of the available wireless channels A, B, C, and D are used by other wireless access points. For example, the wireless access point 122 detects that the wireless channel A is used 70 percent of the time by one or more wireless access points and is not used 30 percent of the time. The wireless access point 122 detects that the wireless channel B is used 72 percent of the time by one or more wireless access points and is not used 28 percent of the time. The wireless access point 122 detects that the wireless channel C is used 50 percent of the time by one or more wireless access points and is not used 50 percent of the time. The wireless access point 122 detects that the wireless channel D is used 18 percent of the time by one or more wireless access points and is not used 82 percent of the time. The wireless access point 122 or other suitable entity stores such information indicating usage (such as interference information) of the different wireless channels over time as interference information 151-B11 as shown in FIG. 4A.

In this example, as shown in FIG. 4B, the wireless access point 123 produces the respective neighbor information 151-A13 based on monitoring the network environment 100 for wireless signals generated by each of the wireless access points.

For example, as previously discussed, the wireless access point 123 broadcasts the wireless signal S3 in the network environment 100. Each of the wireless access points monitors one or more different wireless channels for presence of the wireless signal S3.

The wireless access point 123 monitors for presence of the signals S1, S2, S4, S5, S6, S7, S8, S9, S10, S11, etc. As shown in FIG. 4B, the neighbor information 151-A13 generated by the wireless access point 123 or other suitable entity indicates a degree to which the wireless access point 123 is able to receive wireless communications transmitted from each of the other wireless access points (wireless access point other than the wireless access point 123).

Assume in this example that the respective magnitude of the value in the signal strength column of neighbor information 151-A13 is derived from monitoring each of the different signals S1, S2, S4, S5, S6, S7, S8, S9, S10, S11, . . . , S15, etc. In this example, the signal strength value (such as in dBm) indicates a respective signal strength of the wireless access point 123 receiving corresponding wireless signals from the different wireless access points in the network environment 100. As previously discussed, the greater the magnitude of the signal strength value in dBm, the greater the magnitude that a respective wireless signal is received from the one or more transmitting wireless access points. For example, the signal strength values range from −75 dBm to negative −101 dBm. The signal strength value −75 dBm indicates receipt of a respective wireless signal at a higher power level than a corresponding wireless signal received at the power level −101 dBm.

For a first set of samples monitored by each of the wireless access points at or around time T1, the first wireless access point 123 produces the neighbor interference information 151-A13 to indicate that:
the wireless access point 123 receives the wireless signal S1 transmitted by the wireless access point 121 over wireless channel B at a level (signal strength or wireless power level) of −75 dBm;
the wireless access point 123 receives the wireless signal S2 transmitted by the wireless access point 122 over wireless channel A at a level of −89 dBm;
the wireless access point 123 receives the wireless signal S4 transmitted by the wireless access point 124 over wireless channel B at a level of −79 dBm;
the wireless access point 123 receives the wireless signal S5 transmitted by the wireless access point 125 over wireless channel A at a level of −89 dBm;
the wireless access point 123 receives the wireless signal S6 transmitted by the wireless access point 126 over wireless channel A at a level of −88 dBm;
the wireless access point 123 receives the wireless signal S7 transmitted by the wireless access point 127 over wireless channel D at a level of −78 dBm;
the wireless access point 123 receives the wireless signal S8 transmitted by the wireless access point 128 over wireless channel A at a level of −88 dBm;
the wireless access point 123 receives the wireless signal S9 transmitted by the wireless access point 129 over wireless channel B at a level of −93 dBm;
the wireless access point 123 receives the wireless signal S10 transmitted by the wireless access point 130 over wireless channel B at a level of −101 dBm;
the wireless access point 123 receives the wireless signal S11 transmitted by the wireless access point 131 over wireless channel A at a level of −87 dBm;
the wireless access point 123 receives the wireless signal S13 transmitted by the wireless access point 133 over wireless channel C at a level of −94 dBm; and so on.

Additionally, the wireless access point 123 monitors the degree (such as a percentage of time) to which each of the available wireless channels A, B, C, and D are used by any other wireless access points. For example, the wireless access point 123 detects that the wireless channel A is used 30 percent of the time and is not used 70 percent of the time. The wireless access point 123 detects that the wireless channel B is used 32 percent of the time and is not used 68 percent of the time. The wireless access point 123 detects that the wireless channel C is used 50 percent of the time and is not used 50 percent of the time. The wireless access point 123 detects that the wireless channel D is used 38 percent of the time and is not used 62 percent of the time. The wireless access point 123 or other suitable entity stores such information indicating usage (such as interference information) of the different wireless channels over time as interference information 151-B11 as shown in FIG. 4A.

In a similar manner as previously discussed, the wireless access point 124 or other suitable entity produces the neighbor information 151-A14 and the channel usage information 151-B14; wireless access point 125 or other suitable entity produces the neighbor information 151-A15 in the channel usage information 151-B15; the wireless access point 124 or other suitable entity produces the neighbor information 151-A14 in the channel usage information 151-B14; wireless access point 125 or other suitable entity produces the neighbor information 151-A15 in the channel usage information 151-B15; the wireless access point 124 or other suitable entity produces the neighbor information 151-A14 in the channel usage information 151-B14; wireless access point 125 or other suitable entity produces the neighbor information 151-A15 in the channel usage information 151-B15; and so on.

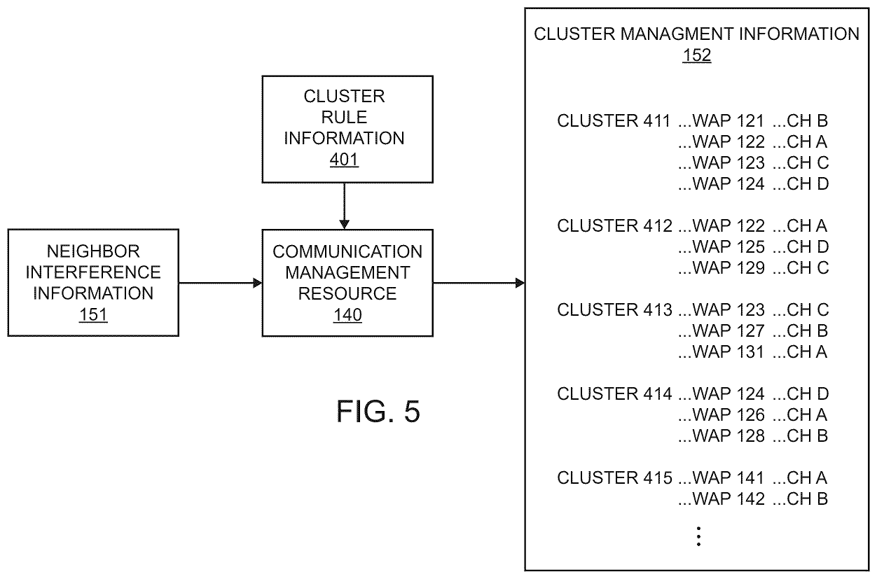

FIG. 5 is an example diagram illustrating generation of cluster management information including groupings of different wireless access points and corresponding allocation of different wireless channels as discussed herein.

Based on analysis of the received instances of neighbor information 151 (feedback) from each of the wireless access points, the communication management resource 140 generates corresponding clusters of wireless access points. The communication management resource 140 utilizes the feedback such as neighbor information 151 from each of the wireless access points to determine different levels of wireless interference susceptibility amongst the wireless access points in the network environment.

The communication management resource 140 groups the wireless access points into the multiple clusters based on the determined different levels of wireless interference susceptibility amongst the wireless access points. In one example, the communication management resource 140 partitions the wireless access points into the multiple clusters independent of knowing actual locations of the wireless access points in the network environment. Although, the neighbor interference information may give some indication whether the wireless access points are near each other or not.

In this example, the communication management resource 140 applies the cluster rule information 401 to identify groupings of wireless access points that are susceptible to interference based on the received neighbor information 151.

For example, based on analysis of the neighbor information 151-A11, the communication management resource 141 determines that the wireless access point 121 is susceptible to wireless interference caused by transmission of wireless communications from a group of wireless access points 122, 123, and 124. Most likely, the susceptibility occurs as a result of the wireless access points 122, 123, and 124, being located nearby the wireless access point 121.

Based on analysis of the neighbor information 151-A12, the communication management resource 141 determines that the wireless access point 122 is susceptible to wireless interference caused by transmission of wireless communications from a group of wireless access points 121, 124, and 125. Most likely, the susceptibility occurs as a result of the wireless access points 121, 124, and 125, being located nearby the wireless access point 122.

Based on analysis of the neighbor interference information 151-A13, the communication management resource 141 determines that the wireless access point 123 is susceptible to wireless interference caused by transmission of wireless communications from a group of wireless access points 121, 124, and 127. Most likely, the susceptibility occurs as a result of the wireless access points 121, 124, and 127, being located nearby the wireless access point 123.

In a similar manner, each of the instances of received neighbor interference information 151-X indicates a respective degree to which the wireless access point experiences potential interference with other wireless access points.

The goal of the communication management resource 140 is to group the different wireless access points into groupings (a.k.a., clusters) such that there is low interference amongst the different member wireless access points included in the cluster. In other words, the communication management resource 140 uses the cluster rule information 401 to strategically group the wireless access points into clusters such that there is low interference amongst the different wireless access points cluster. This can include assigning a different wireless channel for use by each of the wireless access points in the same cluster. The communication management resource 140 assignment of the wireless channels for use by the wireless access points in a cluster includes the communication management resource 140 preventing assignment of a same wireless channel for use by multiple wireless access points assigned to a same cluster of the multiple clusters. In other words, no two wireless access points in the cluster 411 are assigned use of the same wireless channel.

The communication management resource 140 can be configured to receive wireless channel availability information indicating a value M indicating a number of the wireless channels (A, B, C, D) available for assigning to the wireless access points in a single cluster. Based on a magnitude of the value M (such as 4 in this case), the communication management resource 140 selects a first portion of the wireless access points for inclusion in a first cluster of the multiple clusters such that the number of wireless access points in a respective cluster does not exceed the value M. In this example, cluster 414 (first portion of the wireless access points) includes N (2 or 3) wireless access points; wherein N is less than or equal to M.

In accordance with further examples, grouping of the wireless access points into the multiple clusters may include the communication management resource 140 producing a first cluster of the multiple clusters to include the first wireless access point and the second wireless access point in response to detecting that the first wireless access point and the second wireless access point are susceptible to causing wireless interference to each other above a threshold level.

Assume in this example, that the communication management resource 140 has available multiple wireless channels including wireless channel A, wireless channel B, wireless channel C, and wireless channel D for allocating to any of the wireless access points 121, 122, 123, 124, 125, 126, 127, 128, 129, 130, 131, 132, etc., potentially all of which are operated by a respective first wireless network service provider. Note that the wireless access point 137 may be operated by a second wireless network service provider different than the first wireless network service provider. The first wireless network service provider may have no control over what wireless channel is used by the second wireless network service provider and corresponding wireless access point 137.

As previously discussed, based upon the collective neighbor information 151, the communication management resource 140 determines that it is best to produce a first cluster 411 to include wireless access point 121, wireless access point 122, wireless access point 123, and wireless access point 124, because each of these wireless access points is highly susceptible to interference from each other.

The communication management resource 140 produces the respective cluster 411 to include a number of members no greater than the number of available channels (4). In this example, the communication management resource 140 assigns the wireless access point 121 use of the wireless channel B; the communication management resource 140 assigns the wireless access point 122 use of wireless channel A; the communication management resource 140 assigned the wireless access point use of wireless channel C; the communication management resource assigns the wireless access point 124 use of the wireless channel D. In such an instance, assignment of the different wireless channels to each of the members (wireless access points) in the cluster 411 ensures a lower amount of wireless interference amongst each other. The low interference results in very efficient use of the available wireless channels A, B, C, and D.

The communication management resource 140 determines from neighbor information 151-A12 that the wireless access point 122 is susceptible to wireless interference from wireless access points 121, 124, and 125.

The communication management resource 140 determines from neighbor information 151-A13 that the wireless access point 123 is susceptible to wireless interference from wireless access points 121, 124, and 127. Because the member wireless access points in the cluster 414 are susceptible to wireless interference from each other, the communication management resource 140 strategically assigns: i) use of the wireless channel D for use by the wireless access point 124, ii) use of the wireless channel B for use by the wireless access point 128, and iii) use of wireless channel a use by wireless access point 126.

In a similar manner, the communication management resource analyzes the received feedback such as neighbor information 151 and produces the cluster 414 to include wireless access point 124, wireless access point 126, and wireless access point 128. To reduce interference, the wireless access point 124 is assigned use of wireless channel D; the wireless access point 126 is assigned use of the wireless channel A; the wireless access point 128 is assigned channel B.

Accordingly, the communication management resource 140 produces different clusters of wireless access points based upon the neighbor information collected by the wireless access points.

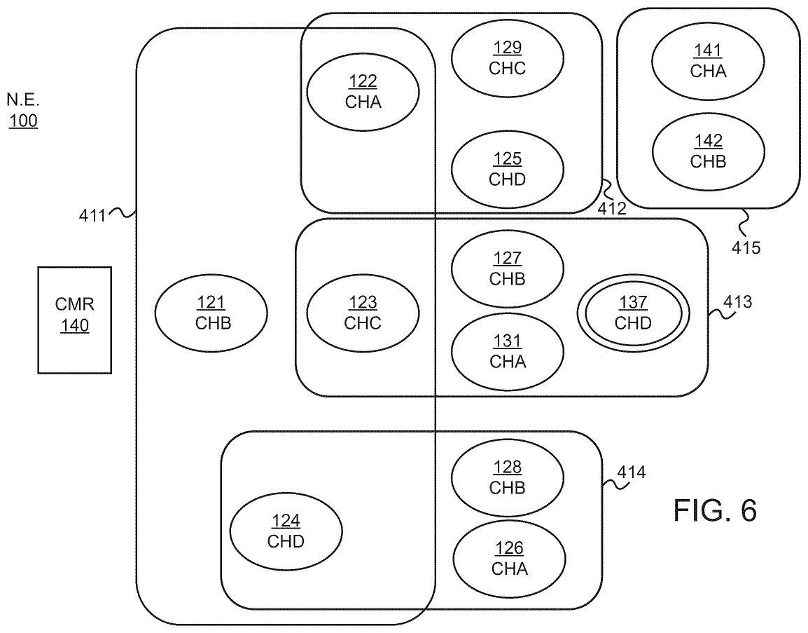

FIG. 6 is an example diagram illustrating logical groupings of different wireless access points and wireless channel allocation as discussed herein.

As previously discussed, the communication management resource 140 produces the respective cluster management information 152 indicating groupings of different wireless access points that are susceptible to wireless communications amongst each other as well as assignment of corresponding wireless channels for use by those wireless access points. These groupings (clusters) and the wireless channel assignments are shown in FIG. 5.

Additionally, the communication management resource 140 communicates with each of the wireless access points to notify them of their corresponding assigned wireless channel. Subsequent to receiving such information, the corresponding wireless access points use the wireless channel (which may be newly assigned or the same channel that they were previously assigned) to support wireless communications with a corresponding mobile communication devices.

In one example, the communication management resource 140 produces the corresponding cluster management information 152 based upon the received instances of neighbor information 151. The communication management resource 140 provides notification of channel assignment to each of the wireless access points based upon the cluster management information 152.

For example, based on the generated cluster management information 152, the communication management resource 141 transmits a first notification to the wireless access point 121, where the first notification notifies the wireless access point 121 to use the wireless channel B when communicating with respective supported communication devices in the network environment 100. This is the same channel that the wireless access point previously used.

Based on the generated cluster management information 152, the communication management resource 141 transmits a second notification to the wireless access point 122, where the second notification notifies the wireless access point 122 to use the wireless channel A when communicating with respective supported communication devices in the network environment 100. This is the same channel that the wireless access point previously used.

Based on the generated cluster management information 152, the communication management resource 141 transmits a third notification to the wireless access point 123, where the third notification notifies the wireless access point 123 to use the wireless channel C when communicating with respective supported communication devices in the network environment 100.

Based on the generated cluster management information 152, the communication management resource 141 transmits a fourth notification to the wireless access point 124, where the fourth notification notifies the wireless access point 124 to use the wireless channel D when communicating with respective supported communication devices in the network environment 100. This is different than the channel B that was previously assigned and used by the wireless access point 124. In other words, the wireless access point 124 is newly assigned channel D instead of channel B.

Based on the generated cluster management information 152, the communication management resource 141 transmits a fifth notification to the wireless access point 125, where the fifth notification notifies the wireless access point 125 to use the wireless channel D when communicating with respective supported communication devices in the network environment 100.

In this manner, each of the wireless access points is notified of a respective wireless channel assigned for its use. The newly assigned wireless channel to each wireless access point may be the same as the previously assigned wireless channel as discussed above or it may be a new wireless channel different than the original assigned wireless channel.

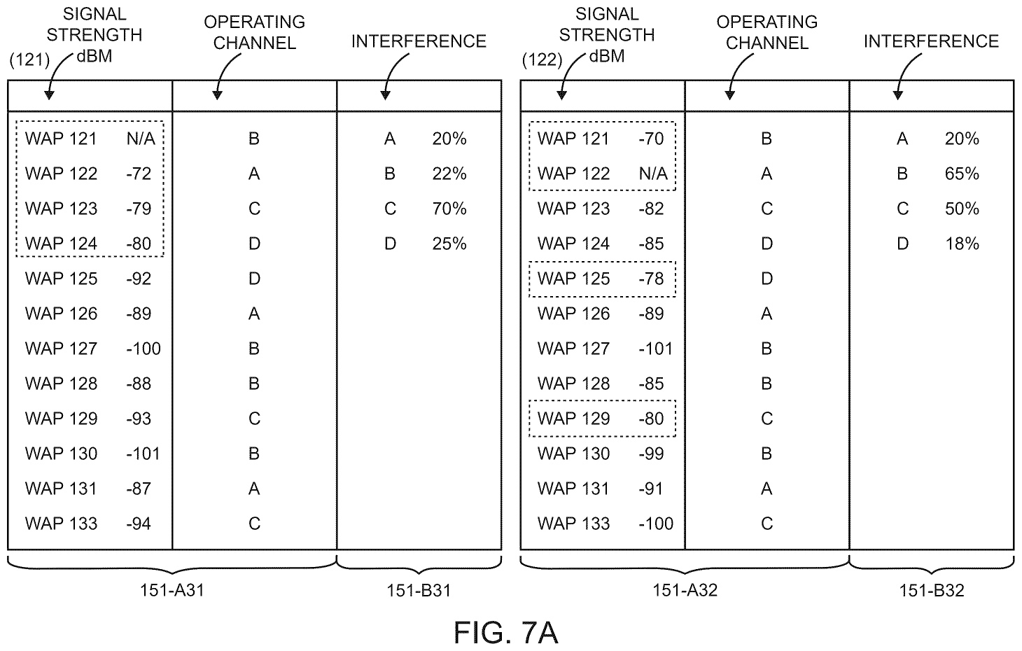

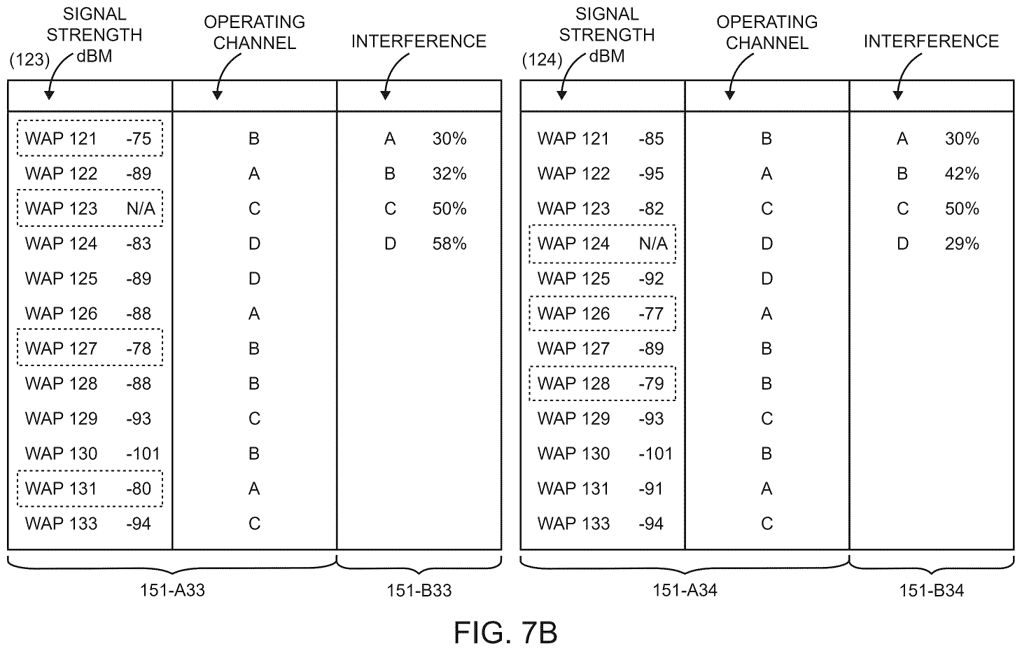

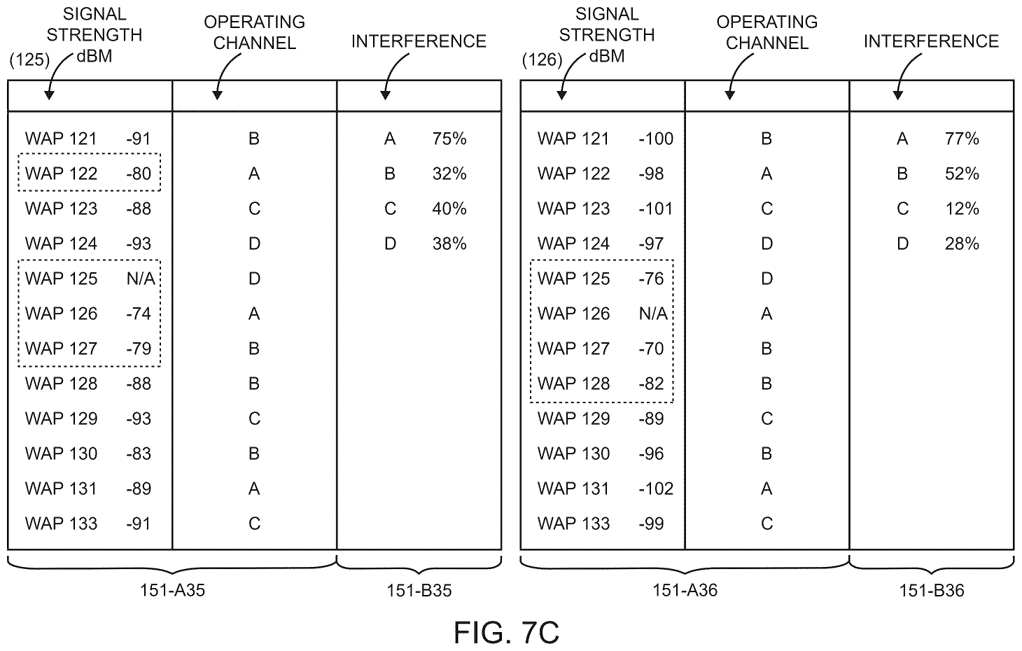

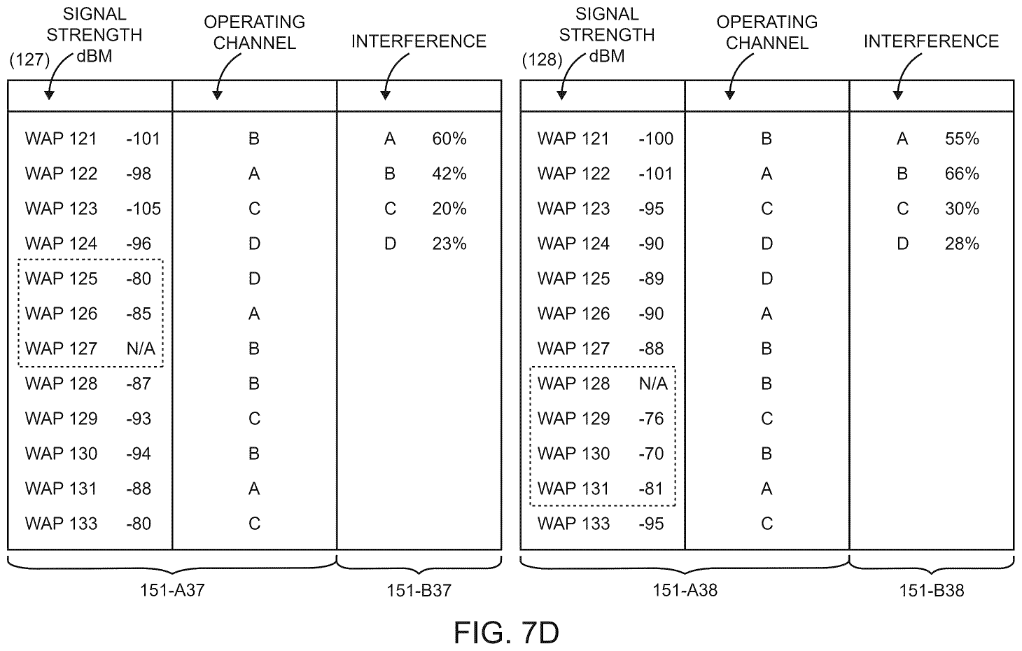

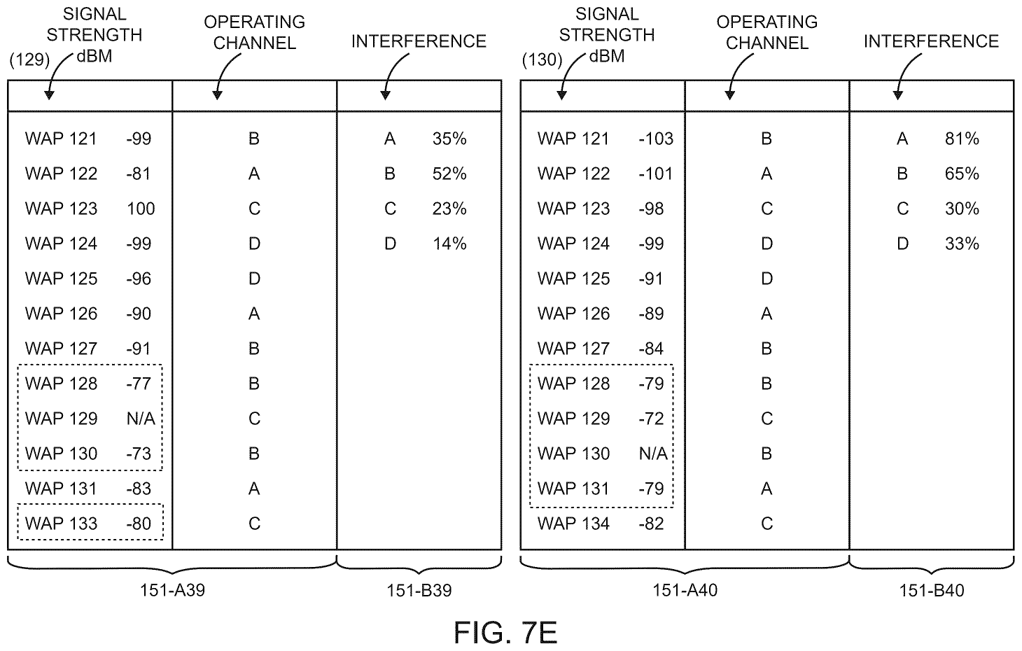

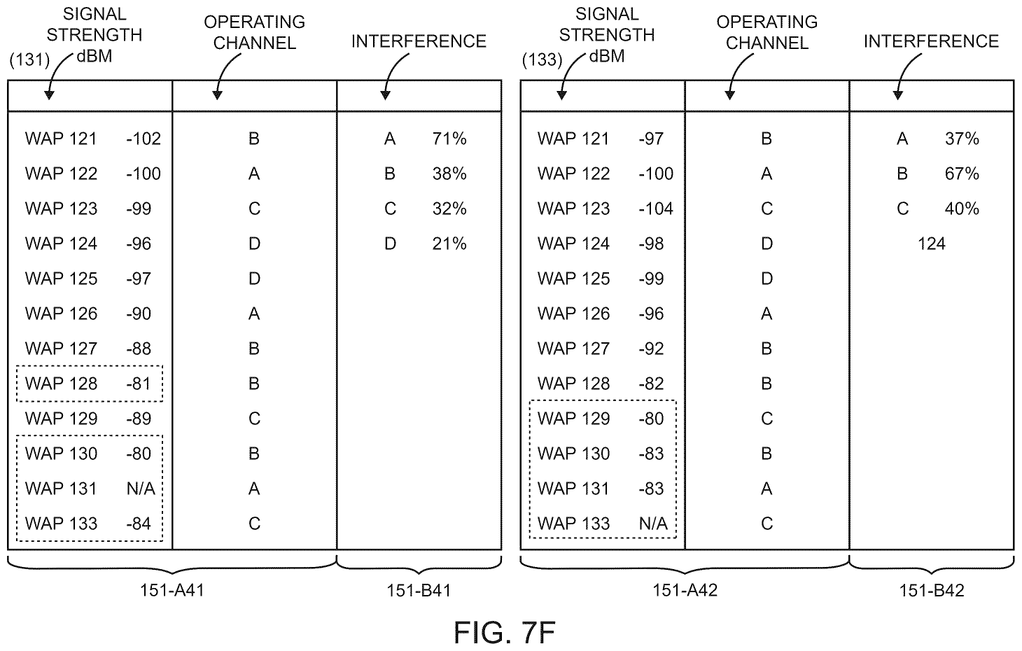

FIGS. 7A, 7B, 7C, 7D, 7E, and 7F are example diagrams illustrating monitoring of neighbor wireless access points and generation of corresponding neighbor information in a similar manner as previously discussed.

In this example, the wireless access point 121 produces the respective neighbor information 151-A31 based on monitoring the network environment 100 for wireless signals generated by each of the other wireless access points at or around time T2, which occurs after time T1.

In a similar manner as previously discussed, the wireless access point 121 broadcasts the wireless signal S1 in the network environment 100. Each of the wireless access points monitors one or more different wireless channels for presence of the wireless signal S1.

The wireless access point 121 monitors for presence of the signals S2, S3, S4, S5, S6, S7, S8, S9, S10, S11, etc. As shown in FIG. 7A, the neighbor information 151-A31 generated by the wireless access point 121 or other suitable entity indicates a degree to which the wireless access point 121 is able to receive wireless communications transmitted from each of the other wireless access points (wireless access point other than the wireless access point 121).

Assume in this example that the respective magnitude of the value in the signal strength column of neighbor information 151-A31 is derived from monitoring each of the different signals S2, S3, S4, S5, S6, S7, S8, S9, S10, S11, . . . , S15, etc.

In this example, the signal strength value (such as in dBm) indicates a respective signal strength of the wireless access point 121 receiving corresponding wireless signals from the different wireless access points in the network environment 100.

For a second set of samples monitored by each of the wireless access points at or around time T2, the first wireless access point 121 produces the neighbor interference information 151-A31 to indicate that:
the wireless access point 121 receives the wireless signal S2 transmitted by the wireless access point 122 over wireless channel A at a level of −72 dBm;
the wireless access point 121 receives the wireless signal S3 transmitted by the wireless access point 123 over wireless channel C at a level of −79 dBm;
the wireless access point 121 receives the wireless signal S4 transmitted by the wireless access point 124 over wireless channel D at a level of −80 dBm;
the wireless access point 121 receives the wireless signal S5 transmitted by the wireless access point 125 over wireless channel D at a level of −92 dBm;
the wireless access point 121 receives the wireless signal S6 transmitted by the wireless access point 126 over wireless channel A at a level of −89 dBm;
the wireless access point 121 receives the wireless signal S7 transmitted by the wireless access point 127 over wireless channel B at a level of −100 dBm;
the wireless access point 121 receives the wireless signal S8 transmitted by the wireless access point 128 over wireless channel B at a level of −88 dBm;
the wireless access point 121 receives the wireless signal S9 transmitted by the wireless access point 129 over wireless channel C at a level of −93 dBm;
the wireless access point 121 receives the wireless signal S10 transmitted by the wireless access point 130 over wireless channel B at a level of −101 dBm;
the wireless access point 121 receives the wireless signal S11 transmitted by the wireless access point 131 over wireless channel A at a level of −87 dBm;
the wireless access point 121 receives the wireless signal S13 transmitted by the wireless access point 133 over wireless channel C at a level of −94 dBm; and so on.

Additionally, the wireless access point 121 monitors the degree (such as a percentage of time) to which each of the available wireless channels A, B, C, and D are used by other wireless access points. For example, the wireless access point 121 detects that the wireless channel A is used 20 percent of the time and is not used 80 percent of the time. The wireless access point 121 detects that the wireless channel B is used 22 percent of the time and is not used 78 percent of the time. The wireless access point 121 detects that the wireless channel C is used 70 percent of the time and is not used 30 percent of the time. The wireless access point 121 detects that the wireless channel D is used 25 percent of the time and is not used 75 percent of the time. The wireless access point 121 or other suitable entity stores such information indicating usage (such as interference information) of the different wireless channels over time as interference information 151-B31 as shown in FIG. 7A.

In a similar manner as shown in 7A, 7B, 7C, 7D, 7E, and 7F, the wireless access point 122 or other suitable entity produces the neighbor information 151-A32 in the channel usage information 151-B32; wireless access point 123 or other suitable entity produces the neighbor information 151-A33 and the channel usage information 151-B33; the wireless access point 124 or other suitable entity produces the neighbor information 151-A34 and the channel usage information 151-B34; wireless access point 125 or other suitable entity produces the neighbor information 151-A35 and the channel usage information 151-B35; the wireless access point 126 or other suitable entity produces the neighbor information 151-A16 and the channel usage information 151-B16; wireless access point 127 or other suitable entity produces the neighbor information 151-A17 and the channel usage information 151-B17; and so on.

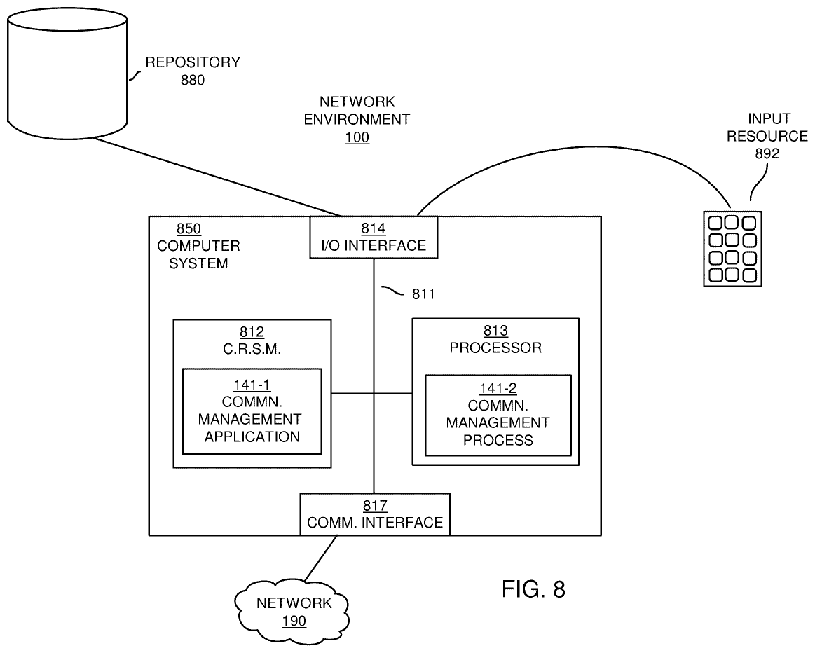

FIG. 8 is an example block diagram of a computer system for implementing any of the operations as previously discussed according to embodiments herein.

Note that any of the resources (such as communication management resource 140, wireless access point, etc.) as discussed herein can be configured to include computer processor hardware and/or corresponding executable instructions to carry out the different operations as discussed herein.

For example, as shown, computer system 850 of the present example includes interconnect 811 coupling computer readable storage media 812 such as a non-transitory type of media or computer readable storage hardware (which can be any suitable type of resource in which digital information can be stored and/or retrieved), a processor 813 (computer processor hardware), I/O interface 814, and a communications interface 817.

I/O interface(s) 814 supports connectivity to repository 880 and input resource 892.

Computer readable storage medium 812 can be any hardware storage device such as memory, optical storage, hard drive, floppy disk, etc. In one embodiment, the computer readable storage medium 812 (computer readable storage hardware) stores instructions and/or data.

As shown, computer readable storage media 812 can be encoded with communication management application 140-1 (such as instantiation of communication management resource 140) in a respective one or more network nodes to carry out any of the operations as discussed herein.

During operation of one example, processor 813 accesses computer readable storage media 812 via the use of interconnect 811 in order to launch, run, execute, interpret or otherwise perform the instructions in management application 140-1 stored on computer readable storage medium 812. Execution of the management application 140-1 produces management process 140-2 to carry out any of the operations and/or processes as discussed herein.

Those skilled in the art will understand that the computer system 850 can include other processes and/or software and hardware components, such as an operating system that controls allocation and use of hardware resources to execute the management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

Functionality supported by the different resources will now be discussed via flowchart 800 in FIG. 8. Note that the steps in the flowcharts below can be executed in any suitable order.

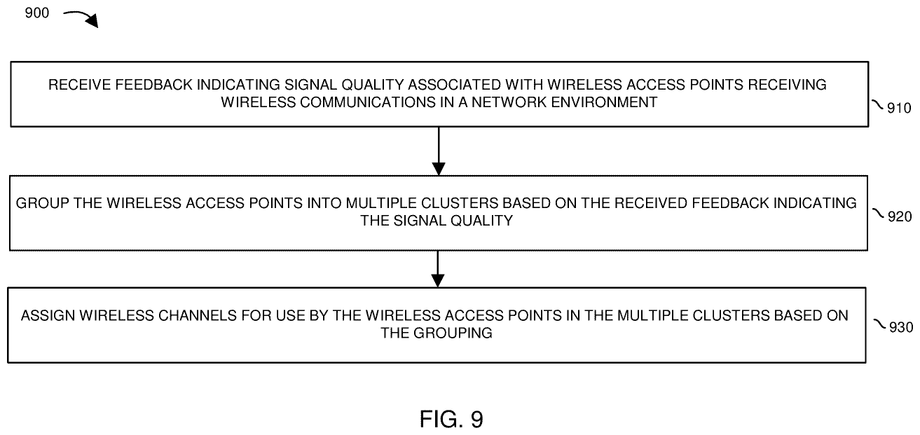

FIG. 9 is a flowchart 900 illustrating an example method according to embodiments herein. Note that there will be some overlap with respect to concepts as discussed above.

In processing operation 910, the communication management resource 140 receives feedback indicating signal quality, and potentially operating channel associated with wireless access points receiving wireless communications in a network environment. As previously discussed, a parameter such as RSSI can be used to determine signal quality. The parameter provides information about how close a transmitting access point is to a monitoring wireless access point measuring respective signal quality of communications received from the transmitting access point.

In processing operation 920, the communication management resource 140 groups the wireless access points into multiple clusters based on the received feedback indicating the signal quality.

In processing operation 930, the communication management resource 140 assigns wireless channels for use by the wireless access points in the multiple clusters based on the grouping.

Note again that techniques herein are well suited to facilitate wireless connectivity and efficient use of wireless channels amongst multiple wireless stations in a network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving feedback indicating signal quality associated with wireless access points receiving wireless communications in a network environment;
grouping the wireless access points into multiple clusters based on the received feedback indicating the signal quality; and
assigning wireless channels for use by the wireless access points in the multiple clusters based on the grouping.

2. The method as in claim 1 further comprising:
utilizing the feedback to determine different levels of wireless interference susceptibility amongst the wireless access points in the network environment.

3. The method as in claim 2 further comprising:
grouping the wireless access points into the multiple clusters based on the determined different levels of wireless interference susceptibility amongst the wireless access points.

4. The method as in claim 1, wherein the wireless access points are partitioned into the multiple clusters independent of knowing actual locations of the wireless access points in the network environment.

5. The method as in claim 1, where grouping the wireless access points into the multiple clusters includes:
receiving wireless channel availability information indicating a value M indicating a number of the wireless channels available for assigning to the wireless access points;
based on a magnitude of the value M, selecting a first portion of the wireless access points for inclusion in a first cluster of the multiple clusters;
wherein the first portion of the wireless access points includes N wireless access points; and
wherein N is less than or equal to M.

6. The method as in claim 1, wherein the feedback indicates signal quality, and operating channel associated with the wireless access points receiving the wireless communications from each other over a first wireless channel.

7. The method as in claim 1, wherein the wireless access points include a first wireless access point and a second wireless access point; and
wherein grouping the wireless access points into the multiple clusters includes producing a first cluster of the multiple clusters to include the first wireless access point and the second wireless access point in response to detecting that the first wireless access point and the second wireless access point are susceptible to causing wireless interference to each other above a threshold level.

8. The method as in claim 7, wherein assigning the wireless channels for use by the wireless access points in the multiple clusters based on the grouping includes:
in response to detecting that the first wireless access point and the second wireless access point belong to the first cluster: i) assigning the first wireless access point use of a first wireless channel, and ii) assigning the second wireless access a second wireless channel, the second wireless channel different than the first wireless channel.

9. The method as in claim 8, wherein grouping the wireless access points into the multiple clusters includes producing a second cluster of the multiple clusters to include the second wireless access point and a third wireless access point in response to detecting that the second wireless access point and the third wireless access point are susceptible to causing wireless interference to each other above the threshold level.

10. The method as in claim 9, wherein assigning the wireless channels for use by the wireless access points in the multiple clusters based on the grouping includes:
in response to detecting that the second wireless access point and the third wireless access point belong to the second cluster and that the second wireless access point is assigned the second wireless channel, assigning the third wireless access point use of a third wireless channel, the third wireless channel different than the second wireless channel.

11. The method as in claim 1, wherein grouping the wireless access points into multiple clusters includes grouping first wireless access points in a first cluster of the multiple clusters and grouping second wireless access points in the second cluster of the multiple clusters; and
wherein the first cluster includes a first wireless access point and the second cluster includes the first wireless access point.

12. The method as in claim 1, wherein assigning the wireless channels for use by the wireless access points includes preventing assignment of a same wireless channel for use by multiple wireless access points assigned to a given cluster of the multiple clusters.

13. The method as in claim 1, wherein first wireless access points are grouped into a first cluster of the multiple clusters; and
wherein assigning the wireless channels for use by the wireless access points in the multiple clusters based on the grouping includes assigning each of first wireless access points in the first cluster use of a different wireless channel.

14. A system comprising:
communication management hardware operative to:
receive feedback indicating signal quality, and operating channel associated with wireless access points receiving wireless communications in a network environment;
group the wireless access points into multiple clusters based on the received feedback indicating the signal quality; and
assign wireless channels for use by the wireless access points in the multiple clusters based on the grouping.

15. The system as in claim 14, wherein the communication management hardware is further operative to:
utilize the feedback to determine different levels of wireless interference susceptibility amongst the wireless access points in the network environment.

16. The system as in claim 15, wherein the communication management hardware is further operative to:
group the wireless access points into the multiple clusters based on the determined different levels of wireless interference susceptibility amongst the wireless access points.

17. The system as in claim 14, wherein the wireless access points are partitioned into the multiple clusters independent of knowing actual locations of the wireless access points in the network environment.

18. The system as in claim 14, wherein the communication management hardware is further operative to:
receive wireless channel availability information indicating a value M indicating a number of the wireless channels available for assigning to the wireless access points;
based on a magnitude of the value M, select a first portion of the wireless access points for inclusion in a first cluster of the multiple clusters;
wherein the first portion of the wireless access points includes N wireless access points; and
wherein N is less than or equal to M.

19. The system as in claim 14, wherein the feedback indicates signal quality and operating channel associated with the wireless access points receiving the wireless communications from each other over a first wireless channel.

20. The system as in claim 14, wherein the wireless access points include a first wireless access point and a second wireless access point; and
wherein the communication management hardware is further operative to: produce a first cluster of the multiple clusters to include the first wireless access point and the second wireless access point in response to detecting that the first wireless access point and the second wireless access point are susceptible to causing wireless interference to each other above a threshold level.

21. The system as in claim 20, wherein the communication management hardware is further operative to:
in response to detecting that the first wireless access point and the second wireless access point belong to the first cluster: i) assigning the first wireless access point use of a first wireless channel, and ii) assigning the second wireless access a second wireless channel, the second wireless channel different than the first wireless channel.

22. The system as in claim 21, wherein the communication management hardware is further operative to:
produce a second cluster of the multiple clusters to include the second wireless access point and a third wireless access point in response to detecting that the second wireless access point and the third wireless access point are susceptible to causing wireless interference to each other above the threshold level.

23. The system as in claim 22, wherein the communication management hardware is further operative to:
in response to detecting that the second wireless access point and the third wireless access point belong to the second cluster and that the second wireless access point is assigned the second wireless channel, assign the third wireless access point use of a third wireless channel, the third wireless channel different than the second wireless channel.

24. The system as in claim 14, wherein the communication management hardware is further operative to:
group first wireless access points in a first cluster of the multiple clusters and grouping second wireless access points in the second cluster of the multiple clusters; and
wherein the first cluster includes a first wireless access point and the second cluster includes the first wireless access point.

25. The system as in claim 14, wherein the communication management hardware is further operative to:
prevent assignment of a same wireless channel for use by multiple wireless access points assigned to a given cluster of the multiple clusters.

26. The system as in claim 14, wherein first wireless access points are grouped into a first cluster of the multiple clusters; and
wherein the communication management hardware is further operative to: assign each of first wireless access points in the first cluster use of a different wireless channel.

27. Computer-readable storage hardware having instructions stored thereon, the instructions, when carried out by computer processor hardware, cause the computer processor hardware to:
receive feedback indicating signal quality, and operating channel, associated with wireless access points receiving wireless communications in a network environment;
group the wireless access points into multiple clusters based on the received feedback indicating the signal quality; and
assign wireless channels for use by the wireless access points in the multiple clusters based on the grouping.
